(19) United States
(12) Patent Application Publication
(10) Pub. No.: US 2015/0288200 A1
(43) Pub. Date: Oct. 8, 2015

(54) METHOD AND APPARATUS FOR INCREASING SAFETY WHEN USING BATTERY SYSTEMS

(71) Applicant: Robert Bosch GmbH, Stuttgart (DE)

(72) Inventors: Hans Partes, Asperg (DE); Holger Fink, Stuttgart (DE); Hans-Joerg Wolff, Schorndorf (DE)

(21) Appl. No.: 14/678,238

(22) Filed: Apr. 3, 2015

(30) Foreign Application Priority Data
Apr. 4, 2014 (DE) 10 2014 206 543.7

(51) Int. Cl. H02J 7/00

(52) U.S. Cl. CPC H02J 7/0016

(57) ABSTRACT

A method for operating a battery system (EB). The battery system (EB) contains at least one battery apparatus. If a safe state of the at least one battery apparatus is brought about from an irregular operating state of the at least one battery apparatus, a present state of the at least one battery apparatus is continually checked and rated by at least one component (CSC) of the battery system and the safe state is brought about on the basis of the present state of the at least one battery apparatus or of an ambient state of the at least one battery apparatus. In that returning the at least one battery apparatus to a regular operating state utilization of at least one of a group including a key, a smartcard, a radio signal, and an input of a security code is required.

### BACKGROUND OF THE INVENTION

The present invention relates to a method and an apparatus for increasing safety when using battery systems and to a battery system and the use thereof.

The prior art discloses methods for increasing safety when using battery systems. By way of example, these involve a state of the battery system being taken as a basis for transferring at least one component of the battery system to a safe state.

A safe state of a battery system or a battery apparatus is a state in which the possibility of harm to living beings or articles that are in the surroundings of the battery system or the battery apparatus is prevented as far as possible. In order to achieve a safe state, it makes sense to switch off, electrically bypass and/or discharge a damaged battery system or a damaged battery apparatus.

By way of example, U.S. Pat. No. 6,211,650 B1 thus discloses a battery system, wherein individual battery cells of the battery system can be transferred to a safe state by means of a bypass circuit on the basis of a state of the battery system.

### SUMMARY OF THE INVENTION

The invention is based on a method for operating a battery system, preferably a lithium ion battery system, containing at least one battery apparatus, wherein if a safe state of the at least one battery apparatus is brought about from an irregular operating state of the at least one battery apparatus, a present state of the at least one battery apparatus is continually checked and rated by at least one component of the battery system and the safe state is brought about on the basis of the present state of the at least one battery apparatus or of an ambient state of the at least one battery apparatus. The present state of the at least one battery apparatus is accordingly monitored by means of a component associated with the at least one battery apparatus and preferably not or only additionally by means of a battery management system that may be provided for operation and for monitoring of a plurality of battery apparatuses. The at least one component, which is preferably an apparatus combination comprising a sensor unit with an evaluation unit and an actuator system, allows autonomous monitoring of the battery apparatus independently of the possible battery management system. Autonomous monitoring is faster and more reliable than monitoring by a battery management system, since it can be performed directly and in situ on the at least one battery apparatus. Since only information about a single battery apparatus needs to be collected and evaluated by means of the at least one component and only the safe state of a single battery apparatus needs to be brought about, the at least one component operates with a lower complexity, more flexibly and with greater energy efficiency than a battery management system that is responsible for monitoring and controlling a plurality of battery apparatuses. If the battery apparatus is a battery cell, cell monitoring electronics represent at least one component by way of example.

An irregular operating state of a battery apparatus is an unforeseen operating state. In this unforeseen operating state, the battery apparatus is unusable or should not be used, for example. A battery apparatus should not be used particularly when safety reasons, for example a fire in the battery apparatus, are an obstacle to use.

The invention relates to a method and a controller for an intrinsically safe battery system and to a battery system and the use thereof.

The essence of the invention is that returning the at least one battery apparatus to a regular operating state requires application of a means, particularly application of a means on the at least one component of the battery system, said means being a key and/or a smartcard and/or a radio signal and/or input of a security code, particularly the input of a security code into the at least one component of the battery system, for example.

A regular operating state of a battery apparatus is a foreseen operating state in which the battery apparatus can be used, for example.

The circumstance that returning the at least one battery apparatus to a regular operating state requires application of a means, particularly application of a means on the at least one component of the battery system, said means being a key and/or a smartcard and/or a radio signal and/or input of a security code, particularly the input of a security code into the at least one component of the battery system, for example, results in an increase in the safety of persons and/or articles in the surroundings in a battery system in which a safety-critical state has arisen. A safety-critical state obtains in the event of gas being produced or a fire within the battery system, for example. The background to the invention is increasing safety when handling battery systems and reducing the probability of damage to a battery system and/or reducing effects of damaged batter systems on the surroundings of the damaged battery systems.

By way of example, a battery system may be damaged when at least one battery apparatus that the battery system contains is itself damaged.

In addition, the circumstance that returning the at least one battery apparatus to a regular operating state requires application of a means prevents unintentional or random return of the at least one battery apparatus to the regular operating state. Unintentional or random return of the at least one battery apparatus to the regular operating state would, in the case of a damaged battery system, be accompanied by an increase in the probability of damage to persons or articles that are in the surroundings of the battery system.

According to the invention, a controller that is suitable for operating the battery system is additionally provided, wherein if a safe state of the at least one battery apparatus is brought about from an irregular operating state of the at least one battery apparatus, a present state of the at least one battery apparatus is continually checked and rated by at least one component of the battery system and the safe state is brought about on the basis of the present state of the at least one battery apparatus or an ambient state of the at least one battery apparatus. In this case, means for returning the at least one battery apparatus to a regular operating state by performing the method according to the invention are provided.

The invention additionally provides a battery system, wherein a controller that is suitable for operating the battery system is provided for the battery system.

Furthermore, the invention covers the use of the method according to the invention and/or the controller according to the invention and/or the battery system according to the invention in vehicle engineering and/or in power engineering.

According to an advantageous refinement of the invention, particularly after the safe state of the at least one battery apparatus is brought about, a hazard information item is transmitted to a battery management system by means of the at least one component of the battery system. In this case, said hazard information item is particularly a hazard information item about the present state of the at least one battery apparatus and/or about the ambient state of the at least one battery apparatus and/or about the circumstance that the at least one battery apparatus is in the safe state.

The circumstance that particularly after the safe state of the at least one battery apparatus is brought about, a hazard information item is transmitted to a battery management system by means of the at least one component of the battery system, said hazard information item being particularly a hazard information item about the present state of the at least one battery apparatus and/or about the ambient state of the at least one battery apparatus and/or about the circumstance that the at least one battery apparatus is in the safe state results in the inventive advantage of the circumstance that a safe state of the at least one battery apparatus has been brought about from an irregular operating state of the at least one battery apparatus being itself checked for necessity. The check on the necessity of bringing about the safe state of the at least one battery apparatus allows sensory errors, in particular, in the at least one component to be checked and if need be precluded. In addition, the hazard information item can be used to determine the extent of the hazard accompanying the irregular operating state, for example.

According to a subsequent preferable embodiment of the invention, the battery management system takes the hazard information item as a basis for monitoring at least one other battery apparatus and/or the at least one battery apparatus by means of a sensor system. In this case, the battery management system, in particular, obtains a check information item, obtained by means of the sensor system, about the at least one other battery apparatus and/or about the at least one battery apparatus. The circumstance that the battery management system obtains a check information item about the at least one other battery apparatus and/or about the at least one battery apparatus results in the inventive advantage of the circumstance that a safe state of the at least one battery apparatus has been brought about from an irregular operating state of the at least one battery apparatus being itself checked for necessity. The check on the necessity of bringing about the safe state of the at least one battery apparatus allows sensory errors, in particular, in the at least one component to be checked and if need be precluded.

In addition, the at least one other battery apparatus can likewise be transferred to a safe state. The at least one other battery apparatus can be transferred to the safe state by the battery management system, for example. Furthermore, the probability of at least one battery apparatus being transferred to the safe state by mistake can be reduced, for example; the reduction of this probability follows from the check on the at least one other battery apparatus. The background to this refinement of the invention is that the check on a state ascertained by means of the at least one component, for example by sensor, can be plausibilized by a check on at least one other battery apparatus that is performed in proximity to the checked battery apparatus. Transferring the at least one battery apparatus by mistake can be caused by a malfunction in the at least one component, for example.

According to a subsequent advantageous refinement of the invention, the battery management system takes the hazard information item and/or the check information item as a basis for bringing about the safe state of the at least one other battery apparatus. In this case, particularly returning the at least one other battery apparatus to its regular operating state requires application of a means, particularly application of a means on the at least one component of the battery system. Said means is a key and/or a smartcard and/or a radio signal and/or input of a security code, particularly the input of a security code into the at least one component of the battery system, for example. Application of the means is necessary particularly when there is an irregular operating state in the at least one other battery apparatus. Alternatively, the hazard information item and/or the check information item can be taken by the battery management system as a basis for returning the at least one battery apparatus to the regular operating state.

In accordance with a further preferred refinement of the invention, the battery system contains at least one battery apparatus and/or at least one other battery apparatus, and the at least one battery apparatus and the at least one other battery apparatus are a battery module or a battery cell.

### BRIEF DESCRIPTION OF THE DRAWINGS

The invention is explained below with reference to exemplary embodiments that can reveal further inventive features, to which the scope of the invention is not limited, however. The exemplary embodiments are shown in the figures, in which:

FIG. 1 shows the schematic illustration of the method according to the invention for increasing safety when using battery systems according to a first embodiment;

FIG. 2 shows the schematic illustration of the method according to the invention for increasing safety when using battery systems according to a second embodiment;

FIG. 3 shows a basic circuit diagram of a battery system that is suitable for bringing about a safe state for at least one battery apparatus that the battery system contains.

### DETAILED DESCRIPTION

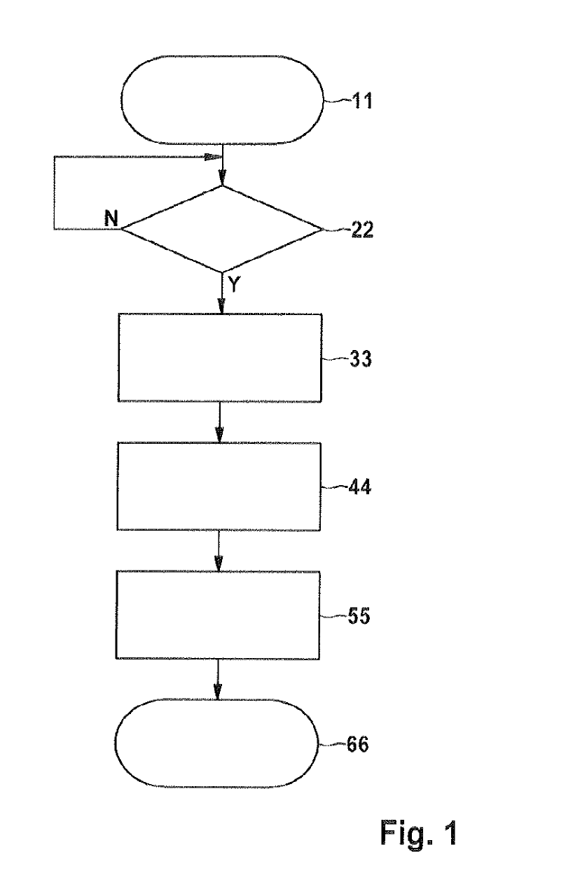

FIG. 1 schematically shows the method according to the invention for increasing safety when using battery systems according to a first embodiment. The battery system contains at least one battery apparatus.

Method initiation step 11 begins the method. In checking step 22, at least one component of the battery system is used to check whether at least one battery apparatus is in a state that necessitates transfer of the at least one battery apparatus to a safe state. By way of example, the check to determine whether such a state obtains can be performed by measuring a value, for example a value of a current that flows through the at least one battery apparatus, a value of a voltage that is applied between two poles of the at least one battery apparatus, a value of a pressure that prevails inside and/or outside the at least one battery apparatus, a value of a temperature that obtains inside and/or outside the at least one battery apparatus and/or a value of a state of charge of the at least one battery apparatus. In this case, the respectively measured value is compared with a minimum threshold value or a maximum threshold value and a check is performed to determine whether the measured value reaches or falls short of or exceeds the minimum threshold value or the maximum threshold value. The at least one battery apparatus needs to be transferred to the safe state when the present state of the battery apparatus has an increased probability of damage to the battery system and/or to the surroundings of the battery system, this possibly being the case when the measured value reaches or falls short of or exceeds the minimum threshold value or the maximum threshold value, for example.

If the at least one battery apparatus is not in such a state, checking step 22 is repeated.

If the at least one battery apparatus is in such a state, on the other hand, the safe state of the at least one battery apparatus is brought about in transfer step 33. In order to bring about the safe state of the at least one battery apparatus, a current bypass can be set and/or a discharge apparatus and/or a fast discharge apparatus can be switched by means of the at least one component, for example.

In the subsequent application step 44, a means for returning the at least one battery apparatus to a regular operating state is applied. This is particularly application of the means on the at least one component of the battery system. Application of the means allows the at least one battery apparatus to be returned to the regular operating state. Return of the at least one battery apparatus is prevented by the at least one component until, and possible only when, the means is applied on the at least one component.

The means is preferably a key and/or a smartcard and/or a radio signal and/or input of a security code. In particular, the means is the input of a security code into the at least one component of the battery system.

In the subsequent return step 55, the at least one battery apparatus is returned to a regular operating state. In method termination step 66, the method is terminated.

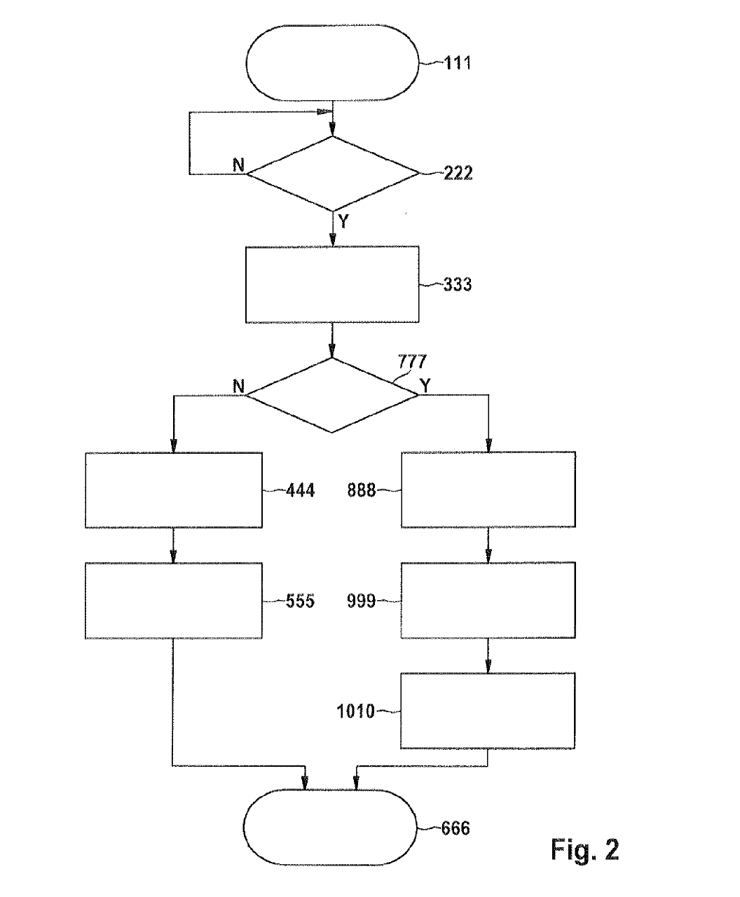

FIG. 2 schematically shows the method according to the invention for increasing safety when using battery systems according to a second embodiment. Method initiation step 111 begins the method. In checking step 222, a check is performed to determine whether at least one battery apparatus is in a state that necessitates transfer of the at least one battery apparatus to a safe state. By way of example, the check to determine whether such a state obtains can be performed by measuring a value, for example a value of a current that flows through the at least one battery apparatus, a value of a voltage that is applied between two poles of the at least one battery apparatus, a value of a pressure that prevails inside and/or outside the at least one battery apparatus, a value of a temperature that obtains inside and/or outside the at least one battery apparatus and/or a value of a state of charge of the at least one battery apparatus. In this case, the respectively measured value is compared with a minimum threshold value or a maximum threshold value and a check is performed to determine whether the measured value reaches or falls short of or exceeds the minimum threshold value or the maximum threshold value. Transfer of the at least one battery apparatus to the safe state is necessary when the present state of the battery apparatus has an increased probability of damage to the battery system and/or to the surroundings of the battery system, this possibly being the case when the measured value reaches or falls short of or exceeds the minimum threshold value or the maximum threshold value, for example. If such a state does not obtain, checking step 222 is repeated.

If such a state obtains, on the other hand, the safe state of the at least one battery apparatus is brought about in transfer step 333. In order to bring about the safe state of the at least one battery apparatus, a current bypass can be set and/or a discharge apparatus and/or a fast discharge apparatus can be switched by means of the at least one component, for example.

In inspection step 777, a check is performed to determine whether at least one other battery apparatus, for example adjacent to the at least one battery apparatus, is likewise in a state that necessitates bringing about a safe state for the at least one other battery apparatus. If such a state does not obtain, a means for returning the at least one battery apparatus to a regular operating state can be applied in application step 444. This involves application of the means on the at least one component of the battery system, in particular. Application of the means allows the at least one battery apparatus to be returned to the regular operating state. Return of the at least one battery apparatus is prevented by the at least one component until, and is possible only when, the means is applied on the at least one component. The means is preferably a key and/or a smartcard and/or a radio signal and/or input of a security code. In particular, the means is the input of a security code into the at least one component of the battery system. A prerequisite for application of the means is that transfer of the at least one battery apparatus to the safe state has been found to be unnecessary in inspection step 777.

If this prerequisite is met, the at least one battery apparatus is returned to the regular operating state in the subsequent return step 555. The subsequent method termination step 666 terminates the method.

If, on the other hand, a state that necessitates bringing about a safe state for the at least one other battery apparatus does not obtain in the at least one other battery apparatus on the basis of inspection step 777, the at least one other battery apparatus is likewise transferred to a safe state in additional transfer step 888. In the subsequent application step 999, a means for returning the at least one other battery apparatus to a regulator operating state is applied. This particularly involves application of the means on at least one other component of the battery system. Application of the means allows the at least one other battery apparatus to be returned to the regular operating state. Return of the at least one other battery apparatus is prevented by the at least one other component until, and is possible only when, the means is applied on the at least one other component.

The means is preferably a key and/or a smartcard and/or a radio signal and/or input of a security code. In particular, the means is the input of a security code into the at least one other component of the battery system.

A prerequisite for application of the means is that transfer of the at least one other battery apparatus to the safe state is found to be unnecessary.

If this prerequisite is met, the at least one battery apparatus is returned to the regular operating state in the subsequent return step 1010.

Method termination step 666 then terminates the method.

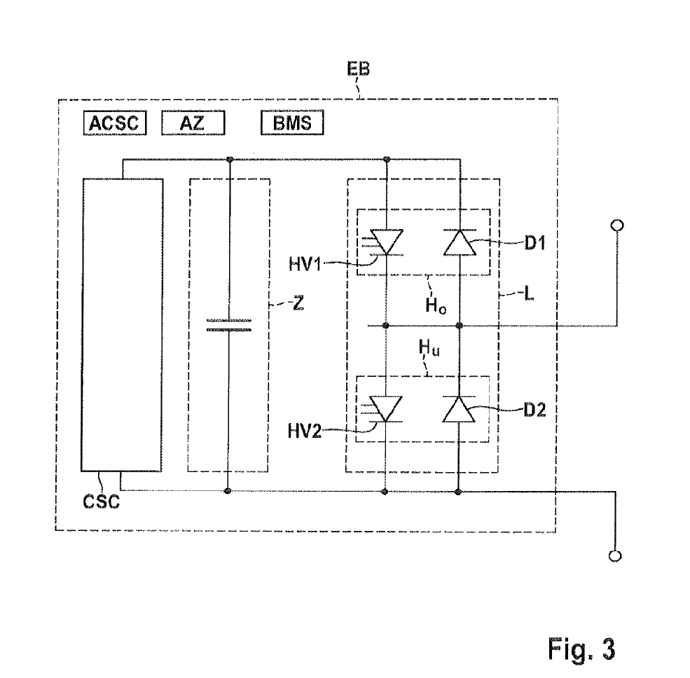

FIG. 3 shows a basic circuit diagram of a battery system EB. The basic circuit diagram shows a battery apparatus, the battery apparatus being a battery cell Z in the basic circuit diagram, and cell monitoring electronics CSC. The battery system EB contains the battery cell Z and the cell monitoring electronics CSC. By way of example, the at least one battery cell Z is a lithium ion battery cell.

The cell monitoring electronics CSC contain a sensor system—not shown—for sensing a state of the at least one battery cell Z. The cell monitoring electronics CSC are therefore used to monitor the at least one battery cell Z.

On the basis of the state of the at least one battery cell Z, the cell monitoring electronics CSC act. The cell monitoring electronics CSC control at least two semiconductor valves HV1 and HV2, which can be switched on and off, and two diodes D1 and D2. One semiconductor valve that can be switched on and off and one diode form a half-bridge arrangement. An upper half-bridge arrangement, containing HV1 and D1, is denoted by H₀ in the drawing, and a lower half-bridge arrangement, containing HV2 and D2, is denoted by Hᵤ. The upper half-bridge arrangement and the lower half-bridge arrangement form a controllable circuit breaker L.

Normally, for example in the regular operating state of a battery system EB, the upper half-bridge arrangement H₀ is switched on and the lower half-bridge arrangement Hᵤ is switched off.

If the cell monitoring electronics CSC identify, on the basis of a state of the battery cell Z, that the battery cell Z needs to be transferred to a safe state, then the upper half-bridge arrangement H₀ is switched off and the lower half-bridge arrangement Hᵤ is switched on. Such a state that necessitates transfer of the battery cell Z to a safe state is an irregular operating state of the battery cell Z. The current then flows no longer through the battery cell Z but rather past the latter through the lower half-bridge arrangement Hᵤ. If the battery cell Z needs to be returned to its regular operating state, application of a means on the cell monitoring electronics CSC is required. By way of example, the means is a key and/or a smartcard and/or a radio signal and/or input of a security code.

In addition, it is possible, by way of example, for another battery cell, adjacent to the battery cell Z and denoted by AZ in the figure, to be checked for the present state of the other battery cell AZ by means of a battery management system denoted by BMS.

The check on the present state of the other battery cell AZ can inspect the circumstance concerning whether the other battery cell AZ likewise needs to be transferred to a safe state, for example. The other battery cell AZ can be transferred to the safe state by means of the battery management system BMS, for example.

Returning the other battery cell AZ from the safe state to the regular operating state can preferably require application of a means on the battery management system BMS. By way of example, the means is a key and/or a smartcard and/or a radio signal and/or input of a security code. In addition, the check on the present state of the other battery cell AZ can be used to inspect the need for bringing about the safe state of the battery cell Z, for example. This makes sense and is possible, for example, when the cell monitoring electronics CSC have established, on the basis of an information item, particularly an information item ascertained by sensor, by way of example a fire, which can be ascertained by sensor on the basis of a temperature, for example, or production of gas, which can be ascertained by sensor on the basis of a gas, for example. In the event of a fire or production of gas, the respective detection is also possible on the other battery cell AZ. The background to the possibility of detecting a fire in the battery cell Z or production of gas on the battery cell Z on the other battery cell AZ is that the present state of the other battery cell AZ can be influenced by the fire in the battery cell Z or the production of gas on the battery cell Z. By way of example, the other battery cell AZ may have other cell monitoring electronics associated with it, denoted by ACSC, for the purpose of checking the present state of the other battery cell AZ.

Furthermore, if it has been found to have been unnecessary to bring about the safe state of the battery cell Z and erroneous operation of the cell monitoring electronics CSC is probable, for example, it is possible for the cell monitoring electronics CSC to be shut down by means of the battery management system BMS.

1. A method for operating a battery system (EB) containing at least one battery apparatus, wherein if a safe state of the at least one battery apparatus is brought about from an irregular operating state of the at least one battery apparatus, a present state of the at least one battery apparatus is continually checked and rated by at least one component (CSC) of the battery system and the safe state is brought about on the basis of the present state of the at least one battery apparatus or of an ambient state of the at least one battery apparatus, characterized in that returning the at least one battery apparatus to a regular operating state requires utilization of at least one of a group including a key, a smartcard, a radio signal, and an input of a security code.

2. The method according to claim 1, characterized in that, a hazard information item is transmitted to a battery management system (BMS) by at least one component (CSC) of the battery system (EB), said hazard information item being a hazard information item about the present state of the at least one battery apparatus and/or about the ambient state of the at least one battery apparatus and/or about the circumstance that the at least one battery apparatus is in the safe state.

3. The method according to claim 2, wherein the hazard information item is transmitted to the battery management system (BMS) by the at least one component (CSC) of the battery system (EB) after the safe state of the at least one battery apparatus is brought about.

4. The method according to claim 2, characterized in that the battery management system (BMS) takes the hazard information item as a basis for monitoring at least one other battery apparatus and, obtains a check information item about the at least one other battery apparatus and/or the at least one battery apparatus.

5. The method according to claim 4, wherein the at least one battery apparatus is monitored by a sensor system.

6. The method according to claim 4, characterized in that the battery management system (BMS) takes the hazard information item and/or the check information item as a basis for bringing about the safe state of the at least one other battery apparatus, wherein returning the at least one other battery apparatus to its regular operating state requires utilization of at least one of a group including a key, a smartcard, a radio signal, and an input of a security code, or the battery management system (BMS) takes the check information item as a basis for returning the at least one battery apparatus to the regular operating state.

7. The method according to claim 1, wherein the battery system (EB) is a lithium ion battery system,

8. The method according to claim 1, wherein returning the at least one battery apparatus to a regular operating state requires utilization the input of a security code into the at least one component (CSC) of the battery system (EB).

9. A controller for a battery system (EB), suitable for operation of the battery system (EB), wherein if a safe state of the at least one battery apparatus is brought about from an irregular operating state of the at least one battery apparatus, a present state of the at least one battery apparatus is continually checked and rated by at least one component (CSC) of the battery system (EB) and the safe state is brought about on the basis of the present state of the at least one battery apparatus or an ambient state of the at least one battery apparatus, characterized in that returning the at least one battery apparatus to a regular operating state is performed using a method according to claim 1.

10. A battery system (EB), characterized in that a controller according to claim 9 is provided.

11. The battery system (EB) according to claim 10, characterized in that the controller contains at least one battery apparatus and said at least one battery apparatus is a battery module or a battery cell (Z).
